(19) United States
(12) Patent Application Publication
(10) Pub. No.: US 2002/0133992 A1
(43) Pub. Date: Sep. 26, 2002

(54) MAGNETIC DISPLAY DEVICE

(76) Inventor: Julie Wu, La Puente, CA (US)

Correspondence Address: Raymond Y. Chan, 1050 Oakdale Lane, Arcadia, CA, 91006, US

(21) Appl. No.: 09/813,434

(22) Filed: Mar. 20, 2001

(51) Int. Cl. G09F 3/18

(52) U.S. Cl. 40/661.01

(57) ABSTRACT

A magnetic display device is adapted for magnetically attaching on a metal surface having a magnetic attraction ability, which includes a back panel having a magnetic rear surface for magnetically attaching on the metal surface, a front panel foldably extended from the back panel edge to edge wherein a receiving cavity is provided between the front panel and the back panel, and a magnetic locker comprising a front flap integrally and outwardly extended from one edge of the front panel wherein the front flap has a magnetic member provided on a rear surface thereof for magnetically attaching the front flap on the metal surface, so as to enclose the receiving cavity by the front panel. Therefore, a desired object such as an address fold is capable of receiving in the receiving cavity such that a user is able to find the desired object at hand.

### BACKGROUND OF THE PRESENT INVENTION

1. Field of Invention

The present invention relates to a magnetic sticker, and more particularly to a magnetic display device adapted for magnetically attaching on a metal surface having a magnetic attraction ability, wherein the magnetic display device is capable of holding a display message such as address fold or business card such that a user is able to locate and find the display message easily.

2. Description of Related Arts

A magnetic sticker becomes one of the home accessories in every single family. People use the magnetic sticker to magnetically stick on a metal surface of a refrigerator for holding a piece of message or a coupon from a detail store. Since the magnetic sticker is manufactured in low cost, which comprises a display plate having a magnetic back surface as shown in FIG. 1, the magnetic sticker is normally given as a gift from the detail store. So, the name of the detail store can be printed on the display plate of the magnetic sticker for advertisement.

However, most people use the magnetic sticker to hold not only the coupon but also pieces of useful information such as phone numbers of police department or fire department so that people can easily find such urgent information at hand. Since there is lots of information needed to be posted, more magnetic stickers are used to attach on the refrigerator, which may look messy and destroy the aesthetic appearance of the house. Thus, such information is not well organized so that when people search for particular information, he or she may need to find it one by one, which is a hassle for the people. Also, such piece of information may get lost easily as well.

### SUMMARY OF THE PRESENT INVENTION

A main object of the present invention is to provide a magnetic display device which is facilitated to place for magnetically attaching on a metal surface having magnetic attraction ability such as a surface of a refrigerator.

Another object of the present invention is to provide a magnetic display device which is adapted for securely holding an address fold therein such that all useful information can be posted on the address fold in a well organized manner, so as to avoid such useful information from being lost from the magnetic display device.

Another object of the present invention is to provide a magnetic display device which is adapted for securely holding an address fold therein, wherein one end of the address fold is attached to the magnetic display device while another free end of the address fold has a dropping down ability in such a manner that all useful information can be read easily at once without detaching the address fold from the magnetic display device.

Another object of the present invention is to provide a magnetic display device which comprises a transparent front pocket such that an ornamental object such as photo or business card can be received in the front pocket of the magnetic display device for his or her own decoration.

Accordingly, in order to accomplish the above objects, the present invention provides a magnetic display device for magnetically attaching on a metal surface having a magnetic attraction ability, which comprising:

a back panel having a magnetic rear surface for magnetically attaching on the metal surface;

a front panel foldably extended from the back panel edge to edge, wherein a receiving cavity is provided between the front panel and the back panel; and

a magnetic locker comprising a front flap integrally and outwardly extended from one edge of the front panel wherein the front flap has a magnetic member provided on a rear surface thereof for magnetically attaching the front flap on the metal surface, so as to enclose the receiving cavity by the front panel.

### BRIEF DESCRIPTION OF THE DRAWINGS

FIG. 1 is a perspective view of a conventional magnetic sticker.

FIG. 2 is a perspective view of a magnetic display device according to a first preferred embodiment of the present invention.

FIG. 3 is a side view of the magnetic display device according to the above first preferred embodiment of the present invention.

FIG. 4A is a rear perspective view of the magnetic display device according to the above first preferred embodiment of the present invention.

FIG. 4B illustrates an alternative mode of a magnetic rear surface of a back panel of the magnetic device according to the above first preferred embodiment of the present invention.

FIGS. 5A and 5B illustrate the magnetic display device equipped with an address fold according to the above first preferred embodiment of the present invention.

FIG. 6 illustrates a first alternative mode of the magnetic display device according to the above first preferred embodiment of the present invention.

FIG. 7 illustrates a second alternative mode of the magnetic display device according to the above first preferred embodiment of the present invention.

FIG. 8 is a perspective view of a magnetic display device according to a second preferred embodiment of the present invention.

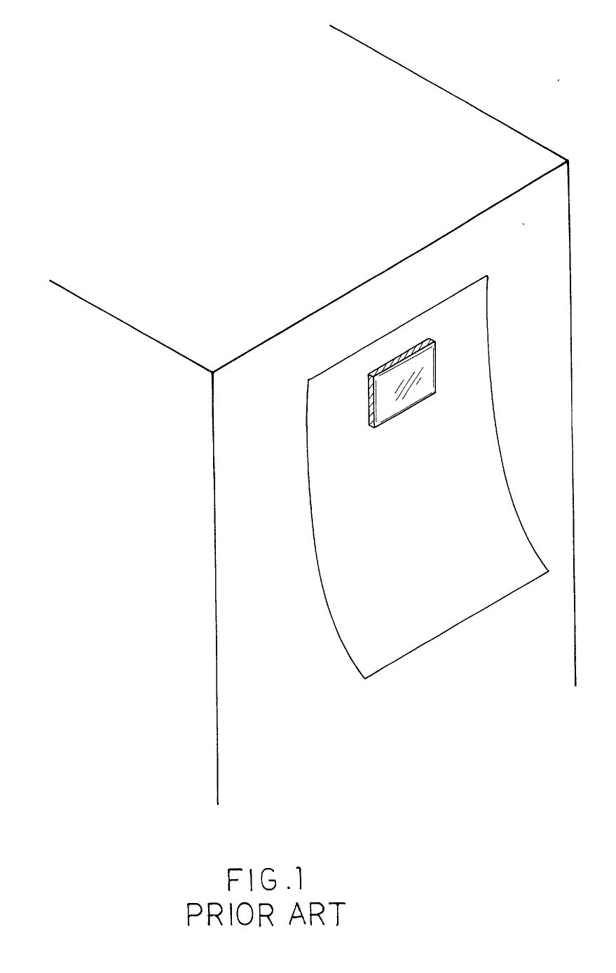

### DETAILED DESCRIPTION OF THE PREFERRED EMBODIMENT

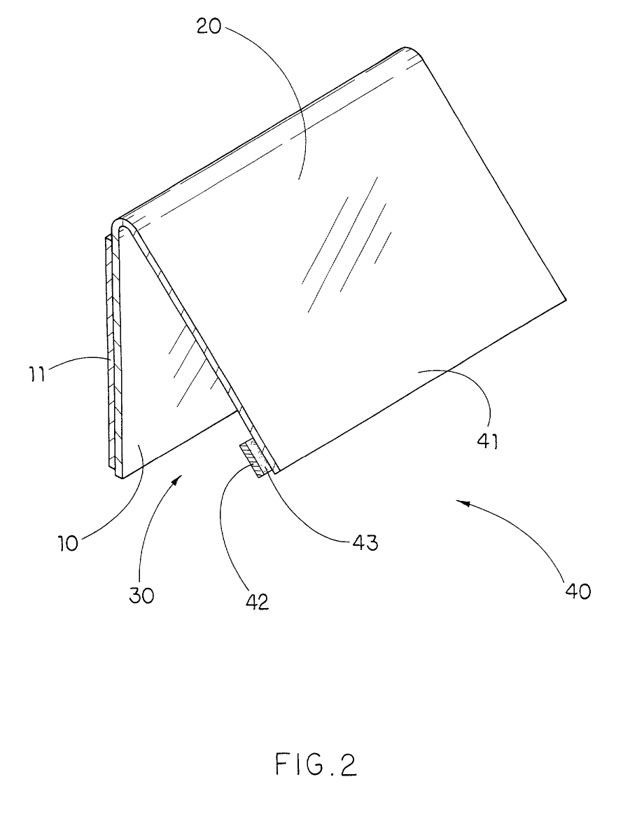

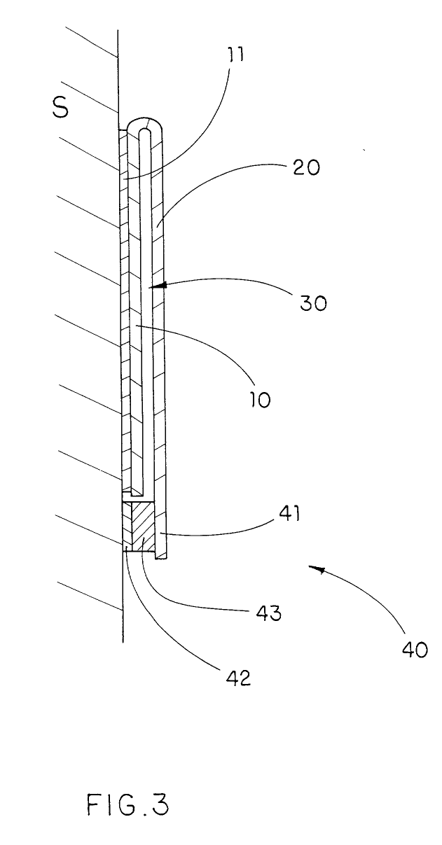

Referring to FIGS. 2 and 3 of the drawings, a magnetic display device according to a preferred embodiment of the present invention is illustrated, wherein the magnetic display device is adapted for magnetically attaching on a metal surface S having a magnetic attraction ability such as a surface of a refrigerator or a metal notice board.

The magnetic display device comprises a back panel 10 having a magnetic rear surface 11 for magnetically attaching on the metal surface S, a front panel 20 foldably extended from the back panel 10 edge to edge, wherein a receiving cavity 30 is provided between the front panel 20 and the back panel 10, and a magnetic locker 40 comprising a front flap 41 outwardly extended from one edge of the front panel 20 wherein the front flap 41 has a magnetic member 42 provided on a rear surface thereof for magnetically attaching the front flap 41 on the metal surface S, so as to enclose the receiving cavity 30 by the front panel 20.

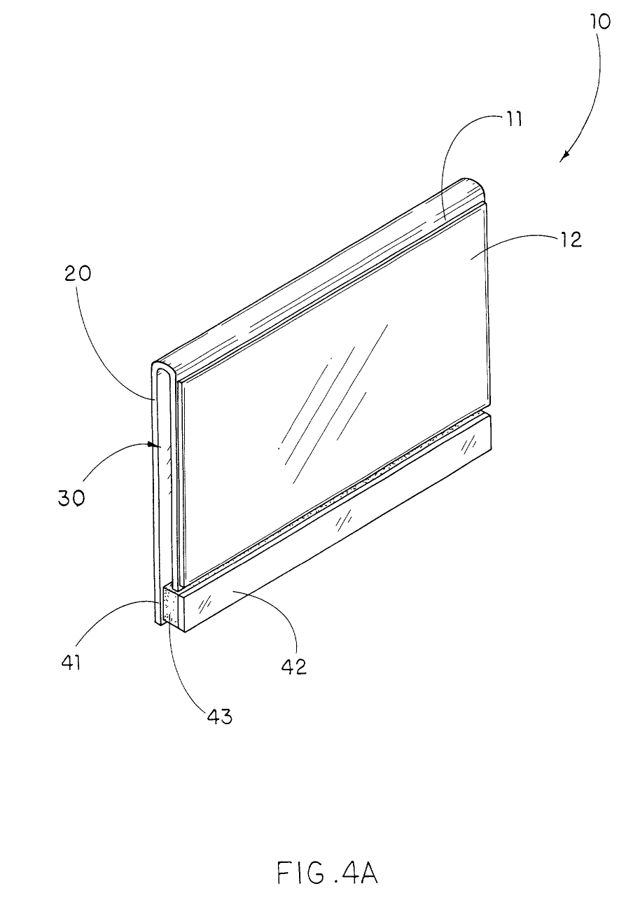

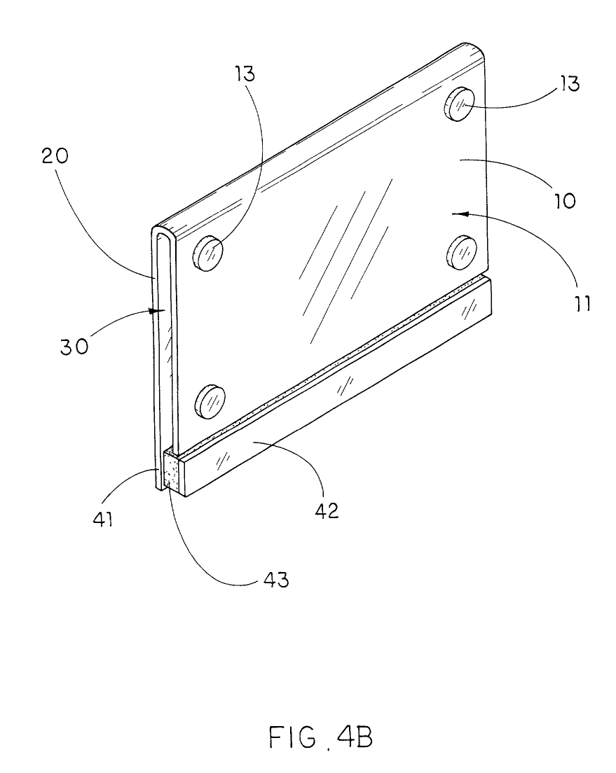

According to the preferred embodiment, the front panel 20 and the back panel 10 of the magnetic display device are formed in a rectangular shape, which can be made of paper or plastic so as to lower the cost of the present invention and easy to manufacture. However, the magnetic display device can be formed any shape according to the need of a user. As shown in FIG. 4A, for providing the magnetic rear surface of the back panel 10, a magnetized piece 12 having a flexibility properties is firmly attached on the entire rear surface of the back panel 10 to form the magnetic rear surface 11 of the back panel 10 wherein the magnetized material is capable of magnetically attaching on the metal surface S, so as to attach the back panel 10 of the magnetic display device on the metal surface S. Alternatively, four pieces of magnet 13 are adapted to be embedded into four corners of the rear surface of the back panel 10 respectively in order to provide the magnetic rear surface 11 of the back panel 10, as shown in FIG. 4B.

The front panel 20 is overlappedly extended from the back panel 10 wherein one edge of the front panel 20 is connected to one edge of the back panel 10 in such a manner that the front panel 20 is adapted for overlappedly folding with respect to the back panel 10, so as to enclose and disclose the receiving cavity 30. Preferably, the front panel 20 has a same size of the back panel 10 so as to fittedly form the receiving cavity 30 therebetween.

The front flap 41 of the magnetic locker 40 is integrally and outwardly extended from the front panel 10 at one edge thereof in such a manner that the magnetic member 42 on the rear surface of the front flap 41 is arranged to magnetically attach on the metal surface S. The magnetic member 42 is made of magnetized material having flexibility properties so as to prevent the magnetic member 42 from being broken while folding the front flap 41.

Accordingly, the magnetic locker 40 further comprises a reinforcing pad 43 mounted between the front flap 41 and the magnetic member 42 wherein the reinforcing pad 43 has a predetermined thickness which is at least the same as a depth of the receiving cavity 30 such that the magnetic member 42 is adapted for fittedly attaching on the metal surface S.

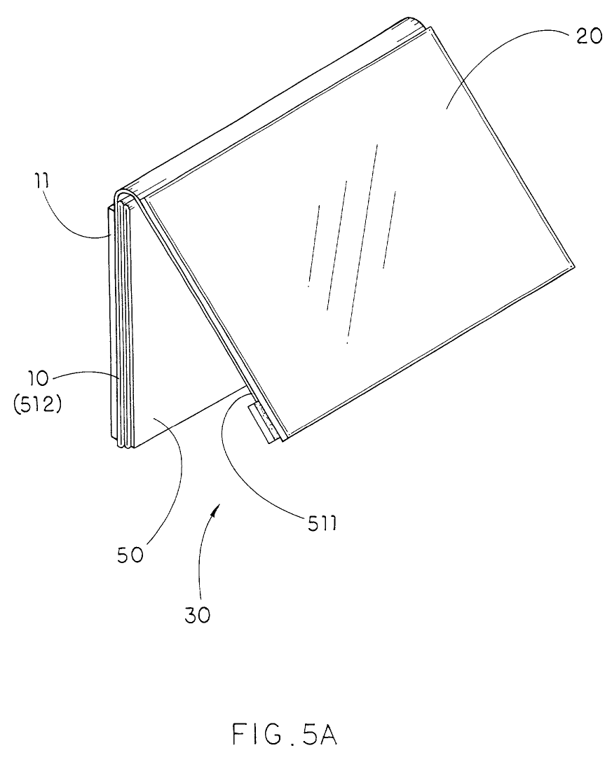

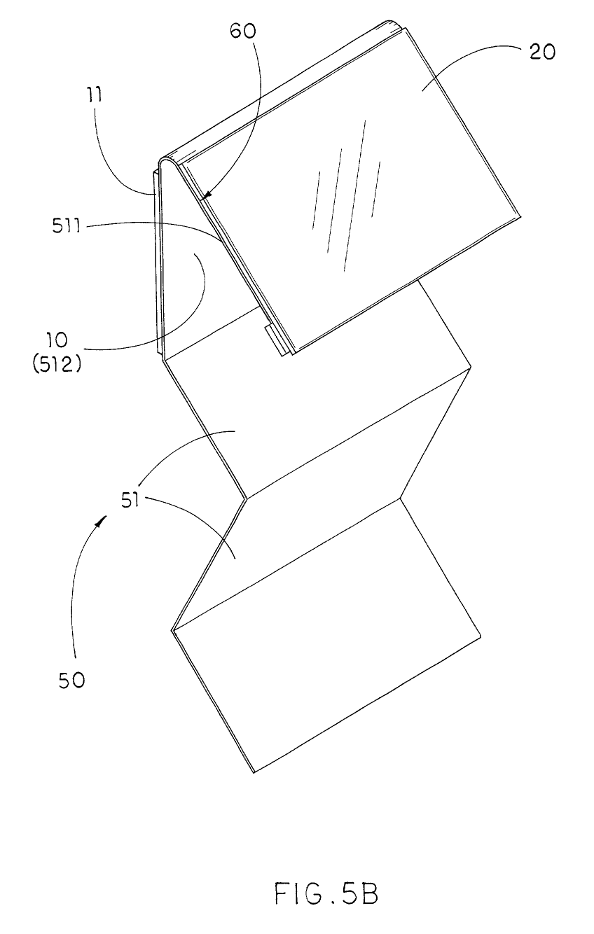

As shown in FIGS. 5A and 5B, the magnetic display device further comprises an address fold 50 fitted received in the receiving cavity 30 wherein the address fold 50 has a plurality of address sections 51 overlappedly folded together in a Z-shaped manner and a holding means 60 for holding one end portion of the address fold 50 in the receiving cavity 30 in such a manner that another end portion of the address fold 50 having a dropping down ability is adapted for unfoldably extending out of the receiving cavity 30.

According to the preferred embodiment, a top address section 511 of the address fold 50 is adhered to a rear surface of the front panel 20 by means of glue (the holding means 60) wherein a second top address section 512 is functioned as the back panel 10 in such a manner that rest of the folded address sections 51 are adapted to be received between the top address section 511 and the second top address section of the address fold 50 and are adapted for freely dropping out of the receiving cavity 30 when the front panel 20 is flipped over. In other words, an entire area of the address fold 50, which is from the top address section 511 to a bottom section of the address fold 50, can be used, so as to enlarge the useable area of the address fold 50.

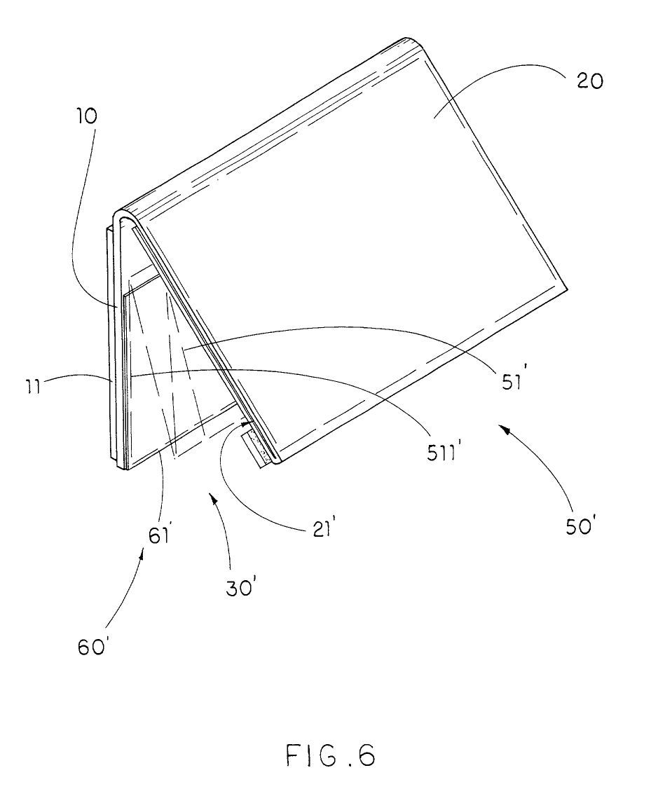

Referring to FIG. 6, a first alternative mode of the magnetic display device is illustrated, wherein the front panel 20′, which is made of plastic, is integrally extended from the back panel 10′. The front panel 20′ comprises a transparent front pocket 21′ for receiving an ornamental object therein such that the ornamental object is adapted for being viewed from outside. The ornamental object can be any photo, business card, or any piece of art that can be inserted into the front pocket 21′ for creating the own decoration of the magnetic display device.

The holding means 60′ comprises a holding pocket 61′ formed on a front surface of the back panel 10′ for detachably inserting the top address section 511′ of the address fold 50′ therein such that rest of the address sections 51′ are adapted for unfoldably dropping down out of the receiving cavity 30′. In other words, the address fold 50′ can be detached and replaced from the magnetic display device so as to bring convenience for a user.

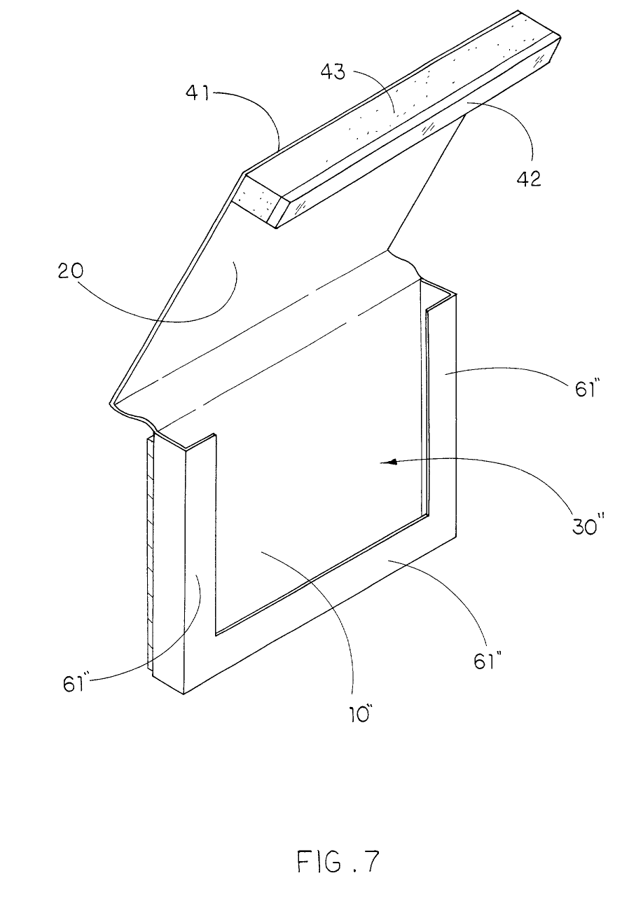

As shown in FIG. 7, a second alternative mode of the magnetic display device according to the preferred embodiment of the present invention is illustrated, wherein the holding means 60″ comprises three edge latches 61″ each having a L-shaped cross section frontwardly extended from three edges of the back panel 10″ respectively such that the three edge latches 61″ are encircling the receiving cavity 30″ for holding the ornamental object therein. The edge latches 61″ having predetermined height define a depth of the receiving cavity 30″ for selectively holding a size of the ornamental object in position. For example, a plurality of business cards (the ornamental object) can be fittedly received in the receiving cavity 30″ while the edge latches 61″ are adapted for holding the business cards in position. Likewise, a bigger ornamental object such as a calculator can also be fitted into the receiving cavity 30″ and supported by the edge latches 61″. So, a user is able to store and well organize his or her useful tools into the magnetic display device, which can be easily found at hand.

While the foregoing description and drawing describe the preferred embodiment and its alternative modes of the present invention, it should be appreciated that certain obvious modifications, variations, and substitutions.

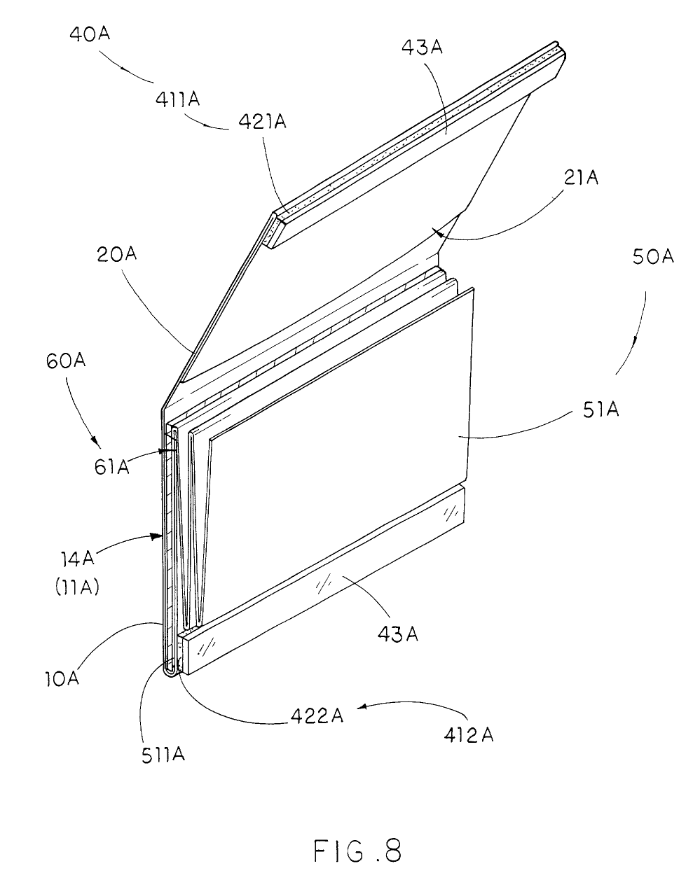

Referring to FIG. 8, a magnetic display device according to a second preferred embodiment of the present invention is illustrated, which basically is a modification of the first alternative mode of the first preferred embodiment of the present invention. The magnetic display device, which is made of plastic, comprises a back panel 10A, a front panel 20A having the same size of the back panel 20A foldably extended therefrom wherein the front panel 20A has a transparent front pocket 21A for receiving an ornamental object therein such that the ornamental object is adapted for being viewed from outside.

The magnetic locker 40A comprises a front flap 411A integrally extended from one edge of the front panel 10A, a back flap 412A integrally extended from a corresponding edge the back panel 20A, a magnetic member 421A provided on a rear surface of the front flap 411A, and a back magnetic member 422A provided on a front surface of the back flap 412A in such a manner the magnetic member 421A is arranged to magnetically attract the back magnetic member 422A so as to enclose the receiving cavity 30A between the front panel 20A and the back panel 10A.

The magnetic locker 40A further comprises a two reinforcing pads 43A mounted on the front magnetic member 421A and the back magnetic member 422A respectively for protecting the front and back magnetic members 421A, 422A.

The holding means 60A comprises a transparent holding pocket 61A formed on a front surface of the back panel 10A wherein a magnetic piece 14A is fittedly received in the holding pocket 61A so as to provide a rear magnetic surface 11A of the back panel 10A. A top address section 511A of an address fold 50A is adapted to be detachably received in the holding pocket 61A such that rest of the address sections 51A of the address fold 50A are adapted for unfoldably dropping down out of the receiving cavity 30A while the front panel 20A is unfolded with respect to the back panel 10A.

It is worth to mention that another ornamental object is capable of receiving in the holding pocket 61A such that both the ornamental objects in the front pocket 21A and the holding pocket 61A are adapted to be viewed from outside.

The advantage of magnetic display device of the second embodiment is that the magnetic display device becomes portable. The user is able to carry the magnetic display device anywhere as an address book wherein when the magnetic display device is not in use, the magnetic display device can be magnetically mounted on the metal surface S so as to prevent being lost. Since the front and back panels 20A, 10A can be decorated by the ornamental objects respectively, the magnetic display device can provide an aesthetic appearance so as to enhance the user carry the magnetic display device as an address book daily.

What is claimed is:

1. A magnetic display device for magnetically attaching on a metal surface having a magnetic attraction ability, which comprises:
a back panel having a magnetic rear surface for magnetically attaching on said metal surface;
a front panel foldably extended from said back panel in an edge to edge manner, wherein a receiving cavity is provided between said front panel and said back panel; and
a magnetic locker comprising a front flap integrally and outwardly extended from one edge of said front panel and a magnetic member provided on a rear surface of said front flap for magnetically folding said front panel with respect to said back panel, so as to enclose said receiving cavity between said front panel and said back panel.

2. A magnetic display device, as recited in claim 1, wherein said magnetic member of said magnetic locker is adapted for magnetically attaching on said metal surface when said front plane is folded up with respect to said back panel.

3. A magnetic display device, as recited in claim 2, further comprising an address fold fitted received in said receiving cavity wherein said address fold has a plurality of address sections overlappedly folded together and a holding means for holding one end section of said address fold in said receiving cavity in such a manner that rest of said address sections of said address fold having a dropping down ability are adapted for unfoldably extending out of said receiving cavity.

4. A magnetic display device, as recited in claim 3, wherein a top address section of said address fold is adhered to a rear surface of said front panel by means of glue and a second top address section of said address fold is said back panel in such a manner that rest of said address sections of said address fold folded in a Z-shaped manner are received between said top address section and said second top address section of said address fold and are adapted for freely dropping out of said receiving cavity while said front panel is flipped over.

5. A magnetic display device, as recited in claim 3, wherein said magnetic locker further comprises a reinforcing pad mounted between said front flap and said magnetic member, wherein said reinforcing pad has a predetermined thickness which is at least the same as a depth of said receiving cavity such that said magnetic member is adapted for fittedly attaching on said metal surface.

6. A magnetic display device, as recited in claim 4, wherein said magnetic locker further comprises a reinforcing pad mounted between said front flap and said magnetic member, wherein said reinforcing pad has a predetermined thickness which is at least the same as a depth of said receiving cavity such that said magnetic member is adapted for fittedly attaching on said metal surface.

7. A magnetic display device, as recited in claim 2, wherein said front panel comprises a transparent front pocket for receiving an ornamental object therein in such a manner that said ornamental object is capable of being seen from outside.

8. A magnetic display device, as recited in claim 3, wherein said front panel comprises a transparent front pocket for receiving an ornamental object therein in such a manner that said ornamental object is capable of being seen from outside.

9. A magnetic display device, as recited in claim 7, wherein said holding means comprises a holding pocket formed on a front surface of said back panel for detachably inserting a top address section of said address fold into said holding pocket in such a manner that rest of said address sections of said address fold folded in a Z-shaped manner are adapted for unfoldably extending out of said receiving cavity.

10. A magnetic display device, as recited in claim 8, wherein said holding means comprises a holding pocket formed on a front surface of said back panel for detachably inserting a top address section of said address fold into said holding pocket in such a manner that rest of said address sections of said address fold folded in a Z-shaped manner are adapted for unfoldably extending out of said receiving cavity.

11. A magnetic display device, as recited in claim 10, wherein said magnetic locker further comprises a reinforcing pad mounted between said front flap and said magnetic member, wherein said reinforcing pad has a predetermined thickness which is at least the same as a depth of said receiving cavity such that said magnetic member is adapted for fittedly attaching on said metal surface.

12. A magnetic display device, as recited in claim 10, wherein said back panel further comprises a magnetized piece having a flexibility properties firmly attached on said entire rear surface of said back panel to form said magnetic rear surface of said back panel for magnetically attaching on said metal surface.

13. A magnetic display device, as recited in claim 10, wherein said back panel further comprises four pieces of magnet embedded into four corners of said rear surface of said back panel to form said magnetic rear surface of said back panel for magnetically attaching on said metal surface.

14. A magnetic display device, as recited in claim 2, further comprising a holding means for holding an ornamental object in said receiving cavity wherein said holding means comprises three edge latches each having a L-shaped cross section frontwardly extended from three edges of said back panel respectively such that said three edge latches are encircling said receiving cavity for holding said ornamental object therein, wherein said three edge latches having predetermined height define a depth of said receiving cavity for selectively holding a size of said ornamental object in position.

15. A magnetic display device, as recited in claim 14, wherein said magnetic locker further comprises a reinforcing pad mounted between said front flap and said magnetic member, wherein said reinforcing pad has a predetermined thickness which is at least the same as a depth of said receiving cavity such that said magnetic member is adapted for fittedly attaching on said metal surface.

16. A magnetic display device, as recited in claim 15, wherein said back panel further comprises a magnetized piece having a flexibility properties firmly attached on said entire rear surface of said back panel to form said magnetic rear surface of said back panel for magnetically attaching on said metal surface.

17. A magnetic display device, as recited in claim 16, wherein said back panel further comprises four pieces of magnet embedded into four corners of said rear surface of said back panel to form said magnetic rear surface of said back panel for magnetically attaching on said metal surface.

18. A magnetic display device, as recited in claim 1, wherein said magnetic locker further comprises a back flap integrally extended from an edge said back panel and a back magnetic member provided on a front surface of said back flap in such a manner that said magnetic member is arranged to magnetically attract said back magnetic member so as to enclose said receiving cavity between said front panel and said back panel.

19. A magnetic display device, as recited in claim 18, further comprising a transparent holding pocket formed on a front surface of said back panel wherein a magnetic piece is fittedly received in said holding pocket so as to provide a rear magnetic surface of said back panel.

20. A magnetic display device, as recited in claim 19, further comprising an address fold having a plurality of address sections fitted received in said receiving cavity wherein a top address section of address fold is detachably inserted into said holding pocket in such a manner that rest of said address sections of said address fold folded in a Z-shaped manner are adapted for unfoldably extending out of said receiving cavity.
